(19) United States
(12) Patent Application Publication
(10) Pub. No.: US 2023/0337225 A1
(43) Pub. Date: Oct. 19, 2023

(54) CONFIGURED GRANT TRANSMISSIONS IN CONTROLLED ENVIRONMENTS

(71) Applicant: InterDigital Patent Holdings, Inc., Wilmington, DE (US)

(72) Inventors: Faris Alfarhan, Montreal (CA); J. Patrick Tooher, Montreal (CA); Aata El Hamss, Laval (CA); Dylan Watts, Montreal (CA)

(73) Assignee: InterDigital Patent Holdings, Inc., Wilmington, DE (US)

(21) Appl. No.: 18/019,550

(22) PCT Filed: Aug. 3, 2021
(86) PCT No.: PCT/US2021/044265

§ 371 Date: Feb. 3, 2023

Related U.S. Application Data
(60) Provisional application No. 63/060,850, filed on Aug. 4, 2020.
(60) Provisional application No. 63/136,273, filed on Jan. 12, 2021.

(51) Int. Cl. H04W 72/1268; H04W 72/232

(52) U.S. Cl. CPC H04W 72/1268; H04W 72/232

(57) ABSTRACT

A device (e.g., a wireless transmit/receive unit (WTRU)) may determine which information (e.g., among multiple transport blocks (TBs)) to be sent on resource(s) of a physical uplink channel (PUCCH) transmission occasion of a configured grant (CG). In an example, the device may receive configuration information. The configuration information may indicate a resource associated with the CG. The device may determine whether to transmit (e.g., on the resource associated with CG) first information of a first TB or second information of a second TB based on one or more of downlink feedback information (DPI) reception, a reason why information of a TB (e.g., the first TB or the second TB) has not been sent in a prior transmission, and a nature of the content (e.g., control information vs. data) in the TB. The first TB may comprise the first information and the second TB may comprise the second information.

### CROSS-REFERENCE TO RELATED APPLICATIONS

This application claims the benefit of Provisional U.S. Patent Application No. 63/060,850, filed Aug. 4, 2020, and Provisional U.S. Patent Application No. 63/136,273, filed Jan. 12, 2021, the disclosure of which are incorporated herein by reference in their entireties.

### BACKGROUND

Mobile communications using wireless communication continue to evolve. A fifth generation of mobile communication radio access technology (RAT) may be referred to as 5G new radio (NR). A previous (legacy) generation of mobile communication RAT may be, for example, fourth generation (4G) long term evolution (LTE).

### SUMMARY

Information in a transport block (TB) of multiple TBs may be sent using resource(s) of a physical uplink channel (PUCCH) transmission occasion of a configured grant (CG). The CG may indicate the PUCCH transmission occasion. A device (e.g., a wireless transmit/receive unit (WTRU)) may determine which information (e.g., among the multiple TBs) to be sent on the resource(s) of the PUCCH transmission occasion of the CG. In an example, the device may receive configuration information. The configuration information may indicate a resource associated with the CG. The device may determine whether to transmit (e.g., on the resource associated with CG) first information of a first TB or second information of a second TB. The first TB may comprise the first information and the second TB may comprise the second information. The device may determine the first TB and the second TB. The device may determine whether to transmit (e.g., on the resource associated with CG) the first information of the first TB or the second information of the second TB based on one or more of downlink feedback information (DFI) reception, a reason why information of a TB (e.g., the first TB or the second TB) has not been sent in a prior transmission, and a nature of the content (e.g., control information vs. data) in the TB.

The device may determine whether to transmit the first information or the second information on the resource associated with the CG based on DFI reception. For example, the device may determine to transmit the first information of the first TB using the resource associated with the CG if the device receives a first feedback of a first prior transmission that comprises the first information, the first feedback indicates that the first information has not been received, and the device has not received DFI on a second prior transmission that comprises the second information. The device may transmit the first information of the first TB using the resource associated with the CG. In examples, the first information may be associated with a first logical channel priority, and the second information may be associated with a second logical channel priority. The first logical channel priority may be equal to or greater than the second logical channel priority.

The device may determine whether to transmit the first information or the second information on the resource associated with the CG based on a reason why the first information of the first TB has not been transmitted and/or a reason why the second information of the second TB has not been transmitted. For example, the device may determine to transmit the first information of the first TB using the resource associated with the CG if the first information has not been transmitted on a first prior resource due to a depriorization of the first TB, and the second information has not been transmitted on a second prior resource due to a listen before talk (LBT) failure. The device may transmit the first information of the first TB using the resource associated with the CG. In examples, the first logical channel priority may be equal to or greater than the second logical channel priority.

The device may determine whether to transmit the first information or the second information on the resource associated with the CG based on a nature of a content of the first TB and/or a nature of content of a second TB. For example, the device may determine to transmit the first information of the first TB using the resource associated with the CG if the first information comprises control information and has not been transmitted on the first prior resource, and the second information comprises data (e.g., only data) and has been transmitted on the second prior transmission. The device may determine to transmit the first information of the first TB using the resource associated with the CG if the first information comprises medium access control (MAC)-control element (CE) and has not been transmitted on the first prior resource, and the second information comprises data (e.g., only data) and has been transmitted on the second prior transmission.

In some examples, the first prior transmission may be the most recent transmission of the first information, and the second transmission may be the most recent transmission of the second information. The first feedback may comprise DFI on the first prior transmission. The first prior transmission may be a PUCCH transmission occasion indicated by a CG or by another uplink grant. The configuration information may indicate that the resource is associated with the PUCCH transmission occasion. The first prior resource and the second prior resource may be different in a time domain and/or in a frequency domain.

A transmission may be sent using the resource associated with the CG. For example, the WTRU may send the transmission based on the determination of whether to transmit the first information or the second information on the resource associated with the CG.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 illustrates an example of a WTRU receiving a downlink control information (DCI) to schedule a dynamic grant (DG) on hybrid automatic repeat request process ID (HARQ PID) before a transport block (TB) transmission and after the WTRU built a protocol data unit (PDU) for the HARQ PID, where the starting time of the DG is before the starting time of the configured grant (CG) and the DG overlaps the CG in the time domain.

FIG. 3 illustrates an example of a WTRU receiving a DCI to schedule a DG on HARQ PID during a TB transmission on a CG occasion and after the WTRU built a PDU for the HARQ PID, where the starting time of the DG is after the starting time of the CG.

FIG. 4 illustrates an example of prioritization used to determine which information of multiple TBs to transmit, for example, on a resource associated with an occasion of a CG.

### DETAILED DESCRIPTION

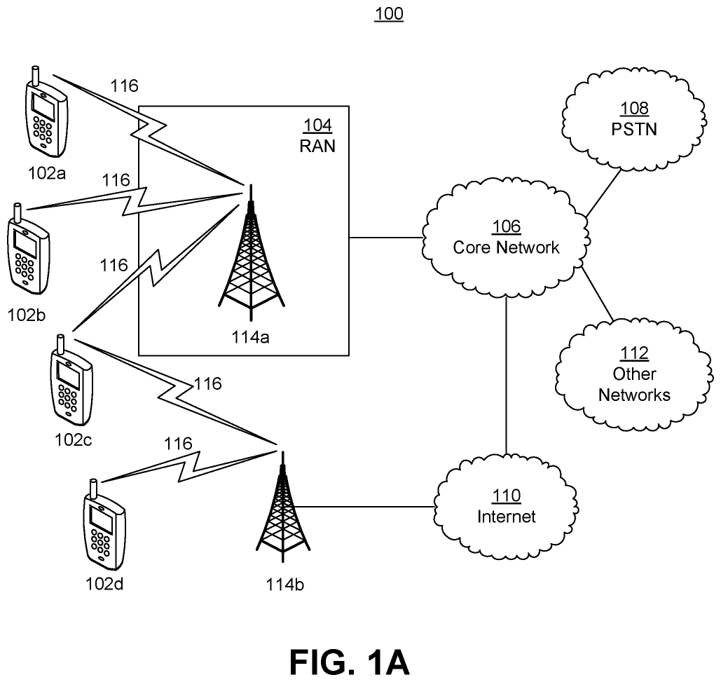

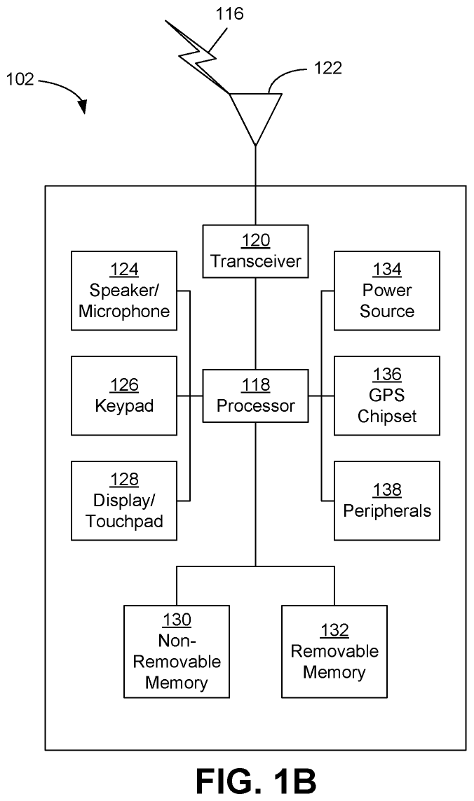

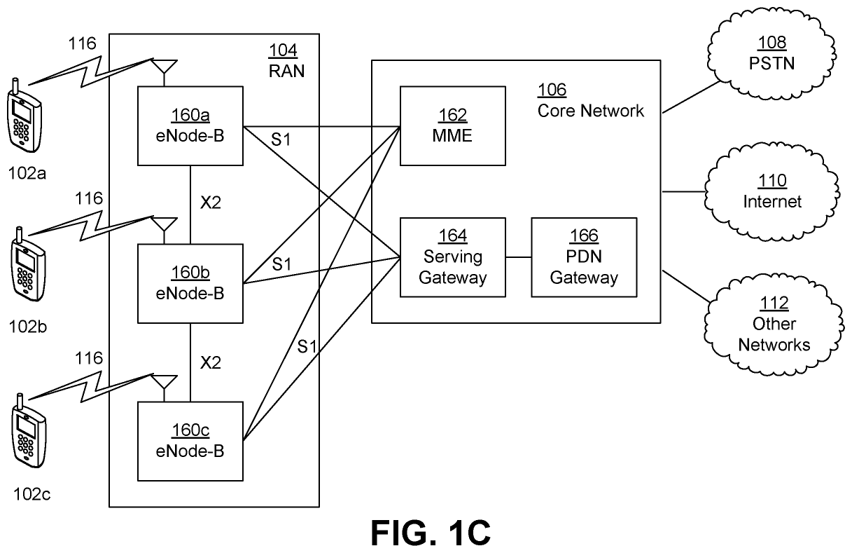

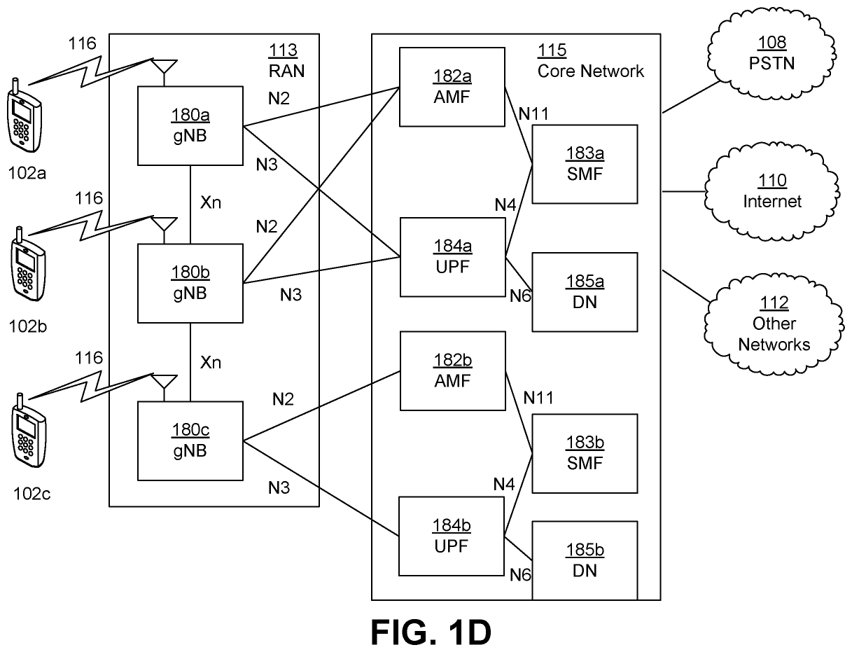

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a‘station’ and/or a‘STA’, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements is depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a,184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Systems, methods, and instrumentalities are described herein for configured grant transmissions in controlled environments. A wireless transmit/receive unit (WTRU) may flush a HARQ process buffer for a transport block (TB) generated for transmission on a configured grant (CG) occasion, for example, if a dynamic grant (DG) of higher priority is signaled for the same hybrid automatic repeat request (HARQ) process and overlaps with the CG in the time domain (e.g., and if the CG transmission has not started). A flushed protocol data unit (PDU) may be mapped to a different HARQ process identifier (PID). A WTRU may map the flushed PDU to a different applicable HARQ PID.

A TB may be transmitted on an overlapping DG if the TB has the same or higher priority. A WTRU may discard a DG if it has the same transport block size (TBS) and/or the same or lower priority as a TB generated for a CG. A WTRU may prioritize between an initial transmission and a retransmission on a CG (e.g., as a function). A WTRU may adjust a reference time delivered by a gNodeB (e.g., as a function).

Information in a transport block (TB) of multiple TBs may be sent using resource(s) of a physical uplink channel (PUCCH) transmission occasion of a configured grant (CG). The CG may indicate the PUCCH transmission occasion. A device (e.g., a wireless transmit/receive unit (WTRU)) may determine which information (e.g., among the multiple TBs) to be sent on the resource(s) of the PUCCH transmission occasion of the CG. In an example, the device may receive configuration information. The configuration information may indicate a resource associated with the CG. The device may determine whether to transmit (e.g., on the resource associated with CG) first information of a first TB or second information of a second TB. The first TB may comprise the first information and the second TB may comprise the second information. The device may determine the first TB and the second TB. The device may determine whether to transmit (e.g., on the resource associated with CG) the first information of the first TB or the second information of the second TB based on one or more of downlink feedback information (DFI) reception, a reason why information of a TB (e.g., the first TB or the second TB) has not been sent in a prior transmission, and a nature of the content (e.g., control information vs. data) in the TB.

The device may determine whether to transmit the first information or the second information on the resource associated with the CG based on DFI reception. For example, the device may determine to transmit the first information of the first TB using the resource associated with the CG if the device receives a first feedback of a first prior transmission that comprises the first information, the first feedback indicates that the first information has not been received, and the device has not received DFI on a second prior transmission that comprises the second information. The device may transmit the first information of the first TB using the resource associated with the CG. In examples, the first information may be associated with a first logical channel priority, and the second information may be associated with a second logical channel priority. The first logical channel priority may be equal to or greater than the second logical channel priority.

The device may determine whether to transmit the first information or the second information on the resource associated with the CG based on a reason why the first information of the first TB has not been transmitted and/or a reason why the second information of the second TB has not been transmitted. For example, the device may determine to transmit the first information of the first TB using the resource associated with the CG if the first information has not been transmitted on a first prior resource due to a depriorization of the first TB, and the second information has not been transmitted on a second prior resource due to a listen before talk (LBT) failure. The device may transmit the first information of the first TB using the resource associated with the CG. In examples, the first logical channel priority may be equal to or greater than the second logical channel priority.

The device may determine whether to transmit the first information or the second information on the resource associated with the CG based on a nature of a content of the first TB and/or a nature of content of a second TB. For example, the device may determine to transmit the first information of the first TB using the resource associated with the CG if the first information comprises control information and has not been transmitted on the first prior resource, and the second information comprises data (e.g., only data) and has been transmitted on the second prior transmission. The device may determine to transmit the first information of the first TB using the resource associated with the CG if the first information comprises medium access control (MAC)-control element (CE) and has not been transmitted on the first prior resource, and the second information comprises data (e.g., only data) and has been transmitted on the second prior transmission.

In some examples, the first prior transmission may be the most recent transmission of the first information, and the second transmission may be the most recent transmission of the second information. The first feedback may comprise DFI on the first prior transmission. The first prior transmission may be a PUCCH transmission occasion indicated by a CG or by another uplink grant. The configuration information may indicate that the resource is associated with the PUCCH transmission occasion. The first prior resource and the second prior resource may be different in a time domain and/or in a frequency domain.

A transmission may be sent using the resource associated with the CG. For example, the WTRU may send the transmission based on the determination of whether to transmit the first information or the second information on the resource associated with the CG.

A WTRU may obtain an already generated TB and transmit it on an overlapping DG, for example, if the TB includes the same or a higher priority (e.g., and if the transport block size (TBS) is the same).

A WTRU may discard a DG, for example, if the DG includes the same TBS and/or the same or lower priority as a TB generated for transmission on a CG.

A WTRU may prioritize between an initial transmission and retransmission(s) on a CG as a function of one or more of the following: a priority of the initial transmission compared to a priority of the retransmission, whether the retransmission is due to uplink (UL) listen-before-talk (LBT), whether the retransmission is due to a CG retransmission timer (CGRT) expiring (e.g., due downlink (DL) LBT failure to receive a downlink feedback information (DFI), whether the retransmission is due to receiving a HARQ acknowledged (ACK) indication or a not acknowledged (NACK) on DFI, whether the retransmission is due to intra-WTRU de-prioritization, and/or whether the PDU includes a high priority MAC CE (e.g., CG confirmation medium access control (MAC) control element (CE), power headroom report (PHR), etc.).

A WTRU may adjust a reference time delivered by a gNodeB (gNB), for example, according to an estimated distance to a target device/node, subcarrier spacing used, a service type, and/or a propagation delay to a target device and/or node.

A WTRU may (e.g., based on mobility) adjust a reference time provided by a source cell to meet synchronization at a target cell. A WTRU may use a timing advance (TA) command provided by a target cell to adjust a reference time provided by a source cell.

Timing compensation may be performed by the network and/or a WTRU.

A WTRU may activate or deactivate WTRU-based timing compensation, for example, based on an explicit or implicit indication from the network.

Wireless (e.g., mobile) communication systems/networks (e.g., new radio (NR)) may support ultra-reliable and low latency communications (URLLC) and/or internet of things (IoT) applications. A transmission duration within a slot may be flexible. There may be multiple configured grant types. In an example (e.g., of a configured grant (CG) type-1 for uplink transmissions), a network may configure (e.g., semi-statically configure) an uplink (UL) grant. A WTRU may use (e.g., autonomously use) the UL grant, for example, without an L1 indication/activation. A CG type-2 (e.g., similar to type-1) may consider L1 indication/activation. Downlink (DL) semi-persistent scheduling (SPS) resources and/or DL CGs may be supported. A WTRU may receive DL data on active DL CGs without scheduling for a DL TB (e.g., each DL TB).

UL and DL services may have different QoS requirements (e.g., traffic of varying latency and/or reliability requirements). Communications may be time-sensitive (TSN). Networking may include deterministic or non-deterministic TSN traffic patterns and/or flows, for example, using licensed or unlicensed spectrum.

A WTRU may be configured with enhanced intra-WTRU overlapping resources prioritization. A configured uplink grant transmission may overlap in time with a dynamically allocated uplink transmission or with another configured uplink grant transmission in the same serving cell. A WTRU may prioritize a transmission, for example, based on a comparison between the highest priority of the logical channels that have data to be transmitted, and which may be multiplexed in medium access control (MAC) protocol data units (PDUs) associated with overlapping resources. A configured uplink grant transmission and/or a dynamically allocated uplink transmission may overlap in time with a scheduling request transmission. A WTRU may prioritize a transmission, for example, based on a comparison between the priority of a logical channel that triggered a scheduling request and the highest priority of logical channels that have data to be transmitted, and which may be multiplexed in a MAC PDU associated with an overlapping resource. In an example, a WTRU may keep a MAC PDU associated with a deprioritized transmission that may have already been generated, for example, to allow a gNodeB (gNB) to schedule a retransmission. A WTRU may be configured by the gNB to transmit the stored MAC PDU as a new transmission using a subsequent resource of the same configured uplink grant configuration, for example, if an explicit retransmission grant is not provided by the gNB.

A WTRU may determine that transmissions (e.g., two or more transmissions of control, data, and/or physical layer signals) overlap, for example, in the time and/or frequency domain. The WTRU may determine (e.g., follow a procedure to determine) which of the overlapping transmissions to transmit and/or multiplex together, for example, based on or after the determination that the transmissions overlap. The WTRU may determine which transmission is prioritized or deprioritized. The WTRU may drop a deprioritized transmission (e.g., discard the grant and/or store the related PDU, if generated for a later time in a HARQ process (re)-transmission) and/or multiplex the deprioritized transmission with another selected transmission. The WTRU may select which of the overlapping transmissions to transmit based on the determination (e.g., designation) of prioritized verse de-prioritized transmission. A transmission may include one or more of a PUSCH transmission, physical uplink control channel (PUCCH) transmission, sounding reference signal (SRS), uplink control information (UCI), scheduling request (SR), or other control information transmission and/or signal. Grant in one or more examples herein may refer to a PUSCH resource applicable for transmission of data and/or control information/element, for example, a dynamic grant (DG) or a configured grant (CG)). A grant (e.g., first grant) may be deprioritized in MAC, for example, if another grant (e.g., second grant) overlaps with the grant and has higher priority LCH(s) from which data may be multiplexed on. A grant (e.g., first grant) may be deprioritized in physical layer (PHY), for example, if another grant (e.g., second grant) or a PUCCH transmission overlaps with the grant and has a higher priority level.

Time synchronization accuracy (e.g., in a TSN) may be dependent on the maximum gNB-to-WTRU distance, for example, if compensation for the radio propagation delay between gNB and WTRU is not provided (e.g., by the WTRU). A maximum timing synchronization error may be dependent on an inter-site/inter-WTRU distance, subcarrier spacing, and/or whether WTRU propagation delay compensation is applied. Clock synchronization requirements may be achieved with accurate reference timing delivery by a gNB to WTRUs (e.g., carried out using broadcast or unicast RRC signaling).

Wireless communication (e.g., NR and LTE RATs) may use unlicensed spectrum. Channel access in an unlicensed frequency band may use a listen-before-talk (LBT) procedure. LBT may be used regardless of whether a channel is occupied. A WTRU may implement a transmission (e.g., an immediate transmission), for example, after a short switching gap.

LBT may be characterized, for example (e.g., in a frame-based system), by one or more of the following: a clear channel assessment (CCA) time (e.g., ˜20 μs), a channel occupancy time (e.g., minimum of 1 ms and/or maximum of 10 ms), an idle period (e.g., minimum of 5% of channel occupancy time), a fixed frame period (e.g., equal to the channel occupancy time plus idle period), a short control signaling transmission time (e.g., maximum duty cycle of 5% within an observation period of 50 ms), and/or a CAA energy detection threshold.

LBT may be characterized, for example (e.g., for a load-based system where a transmit or receive structure may not be fixed in time), by a number N corresponding to the number of clear idle slots in an extended CCA (e.g., instead of a fixed frame period). In examples, N may be selected randomly within a range.

Wireless communication in unlicensed spectrum may vary by RAT (e.g., NR and LTE). For example, unlicensed spectrum operation in a first RAT (e.g., LTE) may implement multiple categories (e.g., two categories) of CCA for UL and DL communications. In a first category, a node may sense a channel for N slot durations, for example, where N may be a random value selected from a range of allowed values (e.g., referred to as a contention window). Contention window size and/or adjustments may depend on a channel access priority. In a license assisted access (LAA) mode, a WTRU may operate in carrier aggregation (CA) with at least one carrier on licensed spectrum. A further enhanced LAA (FeLAA) mode may support autonomous uplink transmissions (AULs), for example, where a WTRU may autonomously transmit on a preconfigured active UL SPS resource, for which explicit HARQ feedback may be provided, e.g., via a downlink feedback information (DFI).

Unlicensed spectrum operation in a second RAT (e.g., NR unlicensed operation (NR-U)) may support stand-alone operation, license assisted operation, dual connectivity (DC) operation, CA operation, initial access, scheduling/HARQ, mobility, and/or coexistence procedures (e.g., with LTE-LAA and other RATs). Operational and/or deployment scenarios (e.g., for NR-U) may include, for example, variations of standalone NR operation (e.g., NR-based operation), DC operation (e.g., E-UTRAN NR (EN)-DC with at least one carrier operating according to the LTE (RAT) or NR DC with at least two sets of one or more carriers operating according to the NR RAT), and/or CA operation (e.g., including different combinations of zero or more carriers of LTE and NR RATs).

NR-U may support CG transmissions and/or block group (CBG)-based transmissions for a CG. In an example (e.g., in an LTE FeLAA system), a WTRU may not generate a retransmission, for example, until an AUL timer has expired and HARQ feedback is not received, or until a not acknowledged (NACK) indication is received (e.g., in DFI). In an example (e.g., in an NR-U system), a WTRU may maintain a CG retransmission timer (CGRT) to control retransmissions on active CG(s), for example, in addition to a CG timer. A CGRT may be started, for example, if a transport block (TB) transmitted on a CG stopped (e.g., based on reception of HARQ feedback in DFI and/or reception of a DG for the same HARQ process). A WTRU may (e.g., based on expiry of a CGRT) determine a NACK for a TB previously transmitted on a CG. The WTRU may (e.g., may be allowed to) attempt another (re)transmission, e.g., on an active configured grant with the same HARQ process identifier (PID).

CG operation may be harmonized, for example, between NR-U and URLLC. Uplink enhancements for URLLC and/or IoT (e.g., industrial IoT (IIoT)) (e.g., in unlicensed controlled environments), may include, for example, support for WTRU-initiated COT for frame-based equipment (FBE) and/or harmonizing UL configured-grant enhancements in NR-U and URLLC for unlicensed spectrum.

A WTRU may be configured with multiple CGs on a given bandwidth part (BWP). Multiple (e.g., a subset of) CGs may be active simultaneously. A CG may be configured (e.g., for NR-U) with both harq-ProcID-Offset and og-RetransmissionTimer. A CG may be configured (e.g., for IIoT) with harq-ProcID-Offset2 (e.g., only harq-ProcID-Offset2), for example, which offset may distinguish CGs overlapping in time (e.g., if a WTRU has multiple active CGs in a BWP configured and/or activated).

A WTRU may select a HARQ PID for an initial transmission for a CG configured for NR-U. A WTRU (e.g., configured with multiple CGs in the same BWP) may configure a HARQ PID pool per CG, for example, using the parameter harq-ProcID-Offset. A WTRU may (e.g., for a CG configured for IIoT) select a HARQ PID according to a formula, such as Formula 1:

HARQ Process ID=[floor(CURRENT_symbol/periodicity)]modulo nrofHARQ-Processes+harq-ProcID-Offset2

HARQ feedback (e.g., in NR-U), for example for a UL PDU transmitted on a CG, may be based on reception (e.g., explicit reception) of an ACK/NACK (e.g., in DFI). Feedback (e.g., in IIoT) may be based on expiry of a CG timer, for example, without receiving a retransmission grant. A WTRU may (e.g., for a transmission on a CG configured for IIoT) select a redundancy version (RV) according to a configured sequence (e.g., including repetitions). RV selection (e.g., for a CG configured for NR-U) may be based on WTRU implementation. A WTRU may include a selected RV and a selected HARQ PID in CG-uplink control information (UCI) on a PUSCH transmission.

A WTRU may (e.g., for NR-U and IIoT) retransmit (e.g., autonomously retransmit) a PDU on a subsequent CG occasion of a CG (e.g., the same CG) and a HARQ process (e.g., the same HARQ process), for example, if the TB failed LBT (e.g., in NR-U) or if the TB was deprioritized due to intra-WTRU prioritization (e.g., in IIoT). A WTRU may prioritize retransmissions before initial transmissions (e.g., for a CG configured for NR-U).

Channel state information (CSI) may include, for example, at least one of the following: a channel quality index (CQI), a rank indicator (RI), a precoding matrix index (PMI), an L1 channel measurement (e.g., reference signal received power (RSRP) such as L1-RSRP or signal-to-interference-plus-noise ratio (SINR)), a CSI-RS resource indicator (CRI), a synchronization signal (SS)/physical broadcast channel (PBCH) block resource indicator (SSBRI), a layer indicator (L1), and/or a measurement quantity (e.g., measured by a WTRU from a configured CSI-RS or SS/PBCH block).

UCI may include, for example, one or more of the following: a CSI, HARQ feedback for one or more HARQ processes, an SR, a link recovery request (LRR), a CG-UCI (e.g., CG may indicate a PUCCH transmission), and/or control information bits (e.g., transmitted on a PUCCH or PUSCH).

Channel conditions may include one or more conditions relating to the state of a radio/channel, which may be determined by a WTRU from, for example, one or more of the following: a WTRU measurement (e.g., L1/SINR/RSRP, CQI/modulation and coding scheme (MCS), channel occupancy, a received signal strength indicator (RSSI), power headroom, and/or exposure headroom), L3/mobility-based measurements (e.g., RSRP and/or reference signal received quality (RSRQ)), an RLM state, and/or channel availability in unlicensed spectrum (e.g., whether the channel is occupied based on a determination of an LBT procedure or whether the channel is deemed to have experienced a consistent LBT failure).

A property of scheduling information (e.g., an uplink grant or a downlink assignment) may include, for example, at least one of the following: a frequency allocation, an aspect of time allocation (e.g., a duration), a priority, an MCS, a TB size, a number of spatial layers, a number of TBs to be carried, a transmission configuration indicator (TCI) state (e.g., configuration information which may indicate that the CG is associated with a PUCCH transmission) or an SRS resource indicator (SRI), a number of repetitions, and/or whether a grant is a CG type 1, CG type 2, or a dynamic grant.

An indication by DCI may include an explicit or implicit indication. In examples, an indication (e.g., explicit indication) by a DCI field or by a radio network identifier (RNTI) may be used to mask a cyclic redundancy check (CRC) of a PDCCH. An implicit indication may include an indication by a property, such as a DCI format, a DCI size, a control resource set (CORESET) or search space, an aggregation level, an identity of a first control channel resource (e.g., an index of a first control channel element (CCE)) for a DCI. A mapping between a property and a value may be signaled (e.g., by RRC or MAC).

A WTRU may be configured with multiple CGs on a given BWP. A subset of CGs may be active simultaneously. CGs (e.g., in NR-U) may be used to autonomously (re)transmit TBs after LBT failure, e.g., to increase the chances of channel acquisition. CGs (e.g., in URLLC and/or IIoT) may be overridden by a higher priority DG. A WTRU may autonomously (re)transmit deprioritized PDUs on subsequent CG occasions, for example, on the same CG and the same HARQ process. A WTRU may select a HARQ process ID for CG transmission (e.g., in NR-U) from a configured pool of PIDs. A WTRU may select a PID for CG transmission (e.g., in IIoT) according to a time-based formula.

CG operation may (e.g., be combined to) support NR-U and/or IIoT operation and/or features, for example, if a CG is not configured in both modes. CG operation in IIoT may be enabled with a CG retransmission timer. A WTRU may select a HARQ PID. A network may be aware (e.g., based on an indication) which PID a WTRU selected. A network may override a CG with a dynamic grant (DG). A HARQ buffer may be occupied before a DG is issued, for example, if the same HARQ process is used to override a CG.

A WTRU may prioritize, for example, between an initial transmission (e.g., a new transmission which may include higher priority data and/or control) over a re-transmission with only data, retransmission(s) due to a UL LBT failure, retransmission(s) due to expiration of a CGRT (e.g., due DL LBT failure to receive DFI), (re)transmission due to intra-WTRU de-prioritization, and/or (re)transmission(s) of a PDU that includes a high priority MAC CE (e.g., a CG confirmation MAC control element (CE), a power headroom report (PHR), etc.). A WTRU may deal with a prioritized transmission on a CG that failed LBT(e.g., in the context of intra-WTRU prioritization).

Timing pre-compensation and/or synchronization may be performed in time sensitive communication networks (TSNs).

TSNs may use a timing synchronization (e.g., require a tight timing synchronization) between end node devices and a grandmaster clock, for example, which the devices (e.g., all the devices) within a TSN are synchronized to. As information is transmitted (e.g., through the 5G RAN network), a propagation delay may introduce a drift in the synchronization between a WTRU and the grandmaster clock.

Synchronization requirements may vary based on a scenario (e.g., an industrial environment or a smart grid) and/or the location of the grandmaster clock (e.g., in a WTRU or an AMF). For example, a synchronization may use a granularity which may not be met by means such as timing advance. In examples, timing requirements may be fulfilled, for example, using network-based pre-compensation techniques (e.g., additional network-based pre-compensation techniques) or WTRU-based pre-compensation techniques.

In examples, the granularity of timing advance, for example, depending on the TSN deployment scenario, may satisfy timing requirements (e.g., without the need for WTRU-based pre-compensation). Techniques may be used to enable or disable WTRU timing pre-compensation, for example, to avoid a double correction of timing advance (e.g., WTRU applies pre-compensation in addition to network based TA) resulting in an incorrect timing modification.

HARQ management may include, for example, one or more procedures for HARQ process buffer management and grant selection and/or prioritization for overlapping grants with the same HARQ PID. A priority of a grant may be determined (e.g., by a WTRU), for example, based on one or more of the following: a priority index indicated by DCI, a scheduling property, an indication by DCI, and/or the highest priority logical channel (LCH) that may be or is already multiplexed for transmission on a grant. A grant may refer to a set of PUSCH resources (e.g., dynamically scheduled by DCI or semi-statically configured by upper layers).

A WTRU may be configured to flush a HARQ process buffer of a transport block generated for a first grant, for example, if a second grant indicates, or is determined for, the same HARQ process ID (e.g., and if the second grant has a higher priority and/or if the two grants overlap in time). In an example, a WTRU may (e.g., may be configured and/or predefined to) flush a HARQ process buffer of a TB generated for a first grant, for example, if a starting time of a second grant is scheduled within a x milliseconds (ms) window before a start of the first grant. The value of x may be predefined and/or configured by a gNB, e.g., based on WTRU capability. In an example, a WTRU may be configured to flush a HARQ process buffer of a TB generated for a first grant, for example, if a starting time of a second grant is scheduled within a y ms window after the start of the first grant transmission. The value of y may be predefined and/or configured by a gNB, e.g., based on one or more WTRU capabilities. In an example, a WTRU may flush a common HARQ process buffer of a TB generated for a first grant, for example, if the second grant is for the same HARQ process, a different transport block size (TBS), and/or a different priority (e.g., a higher priority). A WTRU may map a PDU previously stored in a flushed HARQ PID buffer to another HARQ process ID based on, for example, one or more of the following: the PDU was generated initially for transmission on a configured grant, the mapped HARQ PID is applicable for autonomous (re)transmission on the same or a different configured grant, and/or the configured grant may support the PDU (e.g., with the same or higher TBS).

A WTRU may (e.g., if a second grant is of the same or lower priority than a first grant) transmit a PDU (e.g., the same PDU) already stored in a HARQ PID buffer on one of the grants (e.g., and discard the other) or transmit the same PDU on both grants. A WTRU may (e.g., if a second grant is of a higher priority than a first grant), transmit a PDU (e.g., the same PDU) already stored in a HARQ PID buffer on one of the grants (e.g., and discard the other) or transmit the same PDU on both grants. Transmission of an already generated PDU on a second grant may be based on, for example, an ability to transmit the PDU on the second grant subject to configured logical channel prioritization (LCP) and/or LCH mapping restrictions (e.g., if all or fewer than all LCHs included in the PDU meet LCP and/or LCH selection restrictions associated with the second grant). Transmission of an already generated PDU on a second grant may be based on, for example, whether the TBS of the second grant is greater than or equal to the PDU size and/or the TBS of the first grant. A WTRU may (e.g., if the TBS of a second grant is larger than a PDU size and/or the TBS of the first grant), for example, add padding bits to the second grant to fill the TBS, rebuild the PDU (e.g., without reconstructing data sub PDUs), and/or include further MAC CEs. The WTRU may transmit the PDU already generated for the first grant on both grants, for example, if both grants do not overlap in the time domain.

A WTRU may be configured to prioritize a first grant and discard a second grant (e.g., not transmit the second grant), for example, if both grants have the same HARQ process ID and/or if a DCI scheduling the second grant is received within z ms prior to a start time of a first grant. A WTRU may be configured to prioritize a first grant, for example, even if the first grant has a lower priority than the second grant. In an example, a WTRU may be configured to prioritize a first grant, for example, if a starting time of a second grant is scheduled within an x ms window before the start of the first grant. The value of x may be configured by a gNB, e.g., based on WTRU capability. A WTRU may be configured to prioritize a first grant, for example, if a starting time of a second grant is scheduled within a y ms window after the start of the first grant transmission. The value of y may be configured (e.g., by a gNB), for example, based on WTRU capability.

A WTRU may be configured to prioritize a first grant and discard a second grant (e.g., not transmit the second grant), for example, if both grants have the same HARQ process ID and/or if the priority of the first grant is higher than the priority of the second grant. A WTRU may be configured to prioritize a first grant, for example, if the starting time of a second grant is scheduled within an x ms window before the start of the first grant. The value of x may be configured (e.g., by a gNB), for example, based on WTRU capability. A WTRU may be configured to prioritize a first grant, for example, if a starting time of the second grant is scheduled within a y ms window after the start of the first grant transmission. The value of y may be configured (e.g., by a gNB), for example, based on the WTRU capability.

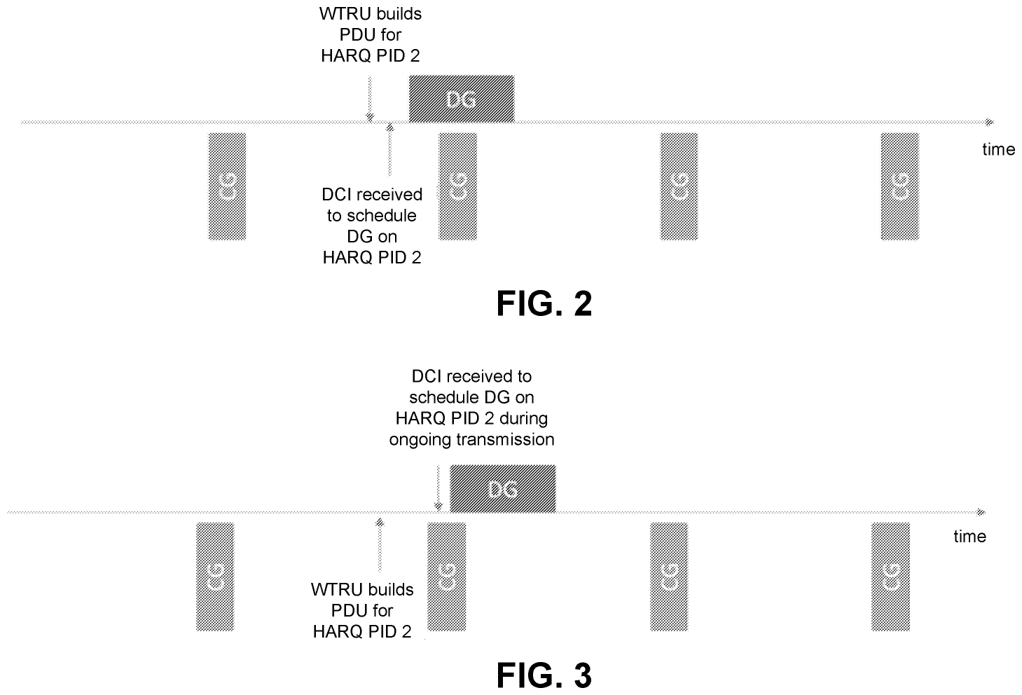

In examples, a first grant may be a UL CG transmission and a second grant may be a UL DG transmission, for example, as shown in FIG. 2 and FIG. 3. FIG. 2 illustrates an example of a WTRU receiving a DCI to schedule a DG on HARQ PID before a TB transmission and after the WTRU built a PDU for the HARQ PID, where the starting time of the DG is before the starting time of the CG and the DG overlaps the CG in the time domain. FIG. 3 illustrates an example of a WTRU receiving a DCI to schedule a DG on HARQ PID during a TB transmission on the CG and after the WTRU built a PDU for the HARQ PID, where the starting time of the DG is after the starting time of the CG.

A WTRU may (e.g., for a CG grant transmission) stop a CG timer associated with an overlapping HARQ process. A WTRU may stop a CGRT associated with a HARQ PID on which overlap happened, e.g., if the CG transmission is deprioritized. A WTRU may, for example, treat a PDU generated for a flushed TB as a deprioritized PDU and associate the PDU with a next available CG resource and/or a different HARQ PID. A WTRU may be configured to use a DG resource (e.g., instead of a CG resource), for example, if the data to be transmitted in a CG is associated with a similar (e.g., same) or higher priority and/or if the indicated TBS on the DG is equal to or higher than the TBS for the CG. A WTRU may be configured to use padding bits, for example, for a larger TBS.

A WTRU may be configured to map and/or move a transport block of a first HARQ process to a second HARQ process, for example, if a WTRU is flushing the data associated with the first HARQ process. For example, a WTRU may prioritize a DG transmission over a CG transmission and both may have the same HARQ PID of value x. A WTRU move, copy. and/or map a TB to another HARQ PID of value y=ƒ(x), for example, before flushing the TB from the HARQ PID x. The mapping function ƒ( ) may be configured (e.g., provided and/or indicated to a WTRU), for example, in the form of a table. A pool and/or a table of M rows may be configured, for example, if a WTRU is configured with M HARQ PIDs that may be used for CG transmissions. A configured table may include two columns (e.g., only two columns for a given HARQ PID), for example, if there is one corresponding HARQ PID (e.g., only one corresponding HARQ PID). A configured table may include more than two columns, for example, if a WTRU has more than one HARQ PID. The function ƒ) may be a function of a CG associated with an original HARQ process. A WTRU may map a PDU to HARQ PIDs applicable to the same CG and/or PIDs configured for a different CG, for example, to have the other CG support the PDU based on the TBS or the configured LCP and/or LCH mapping restrictions.

FIG. 2 illustrates an example of a WTRU receiving a DCI to schedule a DG on HARQ PID before a TB transmission and after the WTRU built a PDU for the HARQ PID, where the starting time of the DG is before the starting time of the CG and the DG overlaps the CG in the time domain. A WTRU may flush a HARQ process buffer for a TB generated for transmission on a different CG occasion, for example, if a DG of higher priority is signaled for the same HARQ process and overlaps in a time domain with the CG (e.g., and if the CG transmission has not started yet). A WTRU may stop a CG timer associated with an overlapping HARQ process (e.g., upon toggling the new data indicator (NDI), flushing the HARQ PID buffer, and/or moving the TB to another HARQ process). A WTRU may stop a CGRT associated with a HARQ PID on which overlap occurred, for example, if the CG transmission is deprioritized. A different CG occasion may belong to anther CG configuration.

A WTRU may map an existing TB to another HARQ PID applicable to a CG transmission. A WTRU may be configured with a number of equivalent HARQ processes on which the WTRU may move TBs. A WTRU may move a TB to another HARQ PID, for example, if the PID is applicable to a CG transmission with the same or higher TBS and/or if the HARQ process is applicable to the same CG configuration. A WTRU may treat a PDU already generated for a CG as a deprioritized PDU and retransmit on a CG occasion (e.g., future CG occasion) associated with a different HARQ PID.

A WTRU may obtain an already generated TB and transmit the TB on an overlapping DG (e.g., using the same HARQ PID on which the overlap has been determined), for example, if the TB is the same or higher priority (e.g., and if the TBS is the same). A WTRU may reconstruct a TB to fit on a DG, for example, if a TBS for the TB is larger than a TBS of an already generated TB.

FIG. 3 illustrates an example of a WTRU receiving a DCI to schedule a DG on HARQ PID during a TB transmission on the CG and after the WTRU built a PDU for the HARQ PID, where the starting time of the DG is after the starting time of the CG. A WTRU may discard a second grant (e.g., a DG), for example, if the second grant (e.g., a DG) has the same TBS and/or if the second grant (e.g., a DG) has an equal or lower priority than a TB generated for transmission on a first grant (e.g., a CG). A WTRU may discard the overlapping second grant (e.g., a DG), for example, if the transmission on the first grant (e.g., a CG) has already started.

A WTRU may interrupt a transmission (e.g., an ongoing transmission that has already started) on a first grant (e.g., a CG) and treat an associated PDU as a deprioritized PDU, for example, if the priority of a second grant (e.g., a DG) is greater than or equal to the priority of the first grant (e.g., a CG). The WTRU may map the deprioritized PDU on the overlapping second grant (e.g., the DG).

A WTRU may transmit the same TB on multiple grants (e.g., two grants), for example, if first and second grants (e.g., DG and CG) do not overlap in time but have the same PID (e.g., and if the TBS is the same as the TBS of both grants and/or if the TBS of each grant is larger than the size of the already stored and/or generated PDU in the HARQ PID buffer). A WTRU may discard a grant with a lower priority, for example, if the grants have different priorities and/or if the later grant starts within k ms from the end (e.g., or start) of the first grant. A WTRU may transmit two different TBs, for example, if the WTRU determines (e.g., receives) an ACK for the transmission of the first grant prior to the start of the second grant and/or receives a toggled NDI prior to the start of the second grant.

A WTRU may prioritize between CG (re)transmission types. A WTRU may be configured with a set of parameters to use for the transmission of a TB. The set of parameters may be configured (e.g., per HARQ process) and/or may be determined (e.g., as a function of the data to transmit in the TB). A set of parameters may be associated with a CG resource. A set of parameters associated with a TB and/or a CG resource may include, for example, at least one of the following: a CGRT, a configured grant timer (CGT), a priority index of a TB, a priority of a TB, an MCS, a TBS, and/or the like.

A CGRT may be a parameter associated with a TB and/or a CG resource. For example, the value of a CGRT may depend on the priority of the data in the TB. In an example, a CGRT may depend on the CG resource used for a transmission.

A CGT may be a parameter associated with a TB and/or a CG resource. For example, the value of a CGT may depend on the priority of the data in the TB. A CGT may depend on the CG resource used for an n-th transmission (e.g., first transmission) of the TB.

A priority index of a TB may be a parameter associated with a TB and/or a CG resource. A WTRU may maintain a priority index for a TB. A priority index may be determined from a priority indication (e.g., in DCI). A priority index may be determined from at least one LCH multiplexed in the TB.

A priority of a TB may be a parameter associated with a TB and/or a CG resource. A WTRU may determine a priority from a priority index (e.g., indicated by DCI), from a scheduling property, from an indication by DCI, and/or from the highest priority LCH that may be multiplexed or is already multiplexed for transmission on an associated grant.

An MCS and/or a TBS may be parameter(s) associated with a TB and/or a CG resource. For example, a TB may be associated with an MCS and/or a TBS.

A WTRU may prioritize between colliding transmissions. A WTRU may transmit (e.g., attempt to transmit) a TB on a CG resource. A WTRU may receive a scheduling DCI indicating that, for example, a DG transmission is expected at the same time as the CG resource (e.g., overlapping in the time domain). A WTRU may transmit a first TB on a first CG resource. A WTRU may transmit (e.g., attempt to transmit) a second TB on a second CG resource and/or on an occasion of the same CG resource, for example, while the CGRT is running. A WTRU may retransmit multiple TBs (e.g., both TBs) in a subsequent CG resource and/or occasion. A TB (e.g., each TB) may be a different transmission from a previous transmission or the current transmission (e.g., a new transmission) or a retransmission. A next CG resource may be applicable to either TB. A WTRU may multiplex transmissions into a single CG resource. A WTRU may include an indication to state and/or indicate, for example, that multiplexing (e.g., of two CG TBs) has occurred in a CG resource, that the sub-PDUs are of the same size and/or that the TBS of the CG occasion may accommodate them. A WTRU may include a subheader in a combined PDU to indicate, for example, where the multiplexed first TB/sub-PDU ends and the next TB starts and/or the number of multiplexed TBs/previously generated sub-PDUs. A subheader may include, for example, the TBS of each sub-PDU.

A WTRU may transmit a TB (e.g., a single TB) in a CG resource. Selection of a TB to transmit may depend on a prioritization rule (e.g., intra-WTRU prioritization rules may be applied to determine which transmission to select and/or transmit). In examples, it may be unfair to transmit (e.g., always transmit) a TB with the highest priority (e.g., as determined by the LCHs), for example, if a lower priority TB may suffer undue latency.

A WTRU may prioritize multiple pending TBs (e.g., all pending TBs) and/or available grants, for example, to determine a TB to transmit (e.g., at a given moment). One or more prioritization rules may depend on, for example, at least one of the following: a priority index, a DCI indicated priority, an LCH priority, whether a transmission is a first transmission or a retransmission, an RV of a transmission, a reason for a transmission, the number of times a TB has not been transmitted, a CAPC to be used for an LBT process to acquire a channel for a transmission, a CGT value, the content of a TB, whether a TB is part of a repetition bundle, and/or the like.

One or more TB prioritization rules may depend on, for example, a priority index. For example, a WTRU may maintain a priority index for a TB (e.g., each TB). An initial value of a priority index may be determined from the data (e.g., the priority thereof) to be transmitted. An initial value of a priority index may be applicable for a new HARQ Process. A priority index may be incremented or decremented, for example, as a function of whether a TB is transmitted when it is originally intended to be transmitted. For example, a TB may have a priority index x. A WTRU may increment the priority index to x+1, for example, if the TB may not be transmitted at its intended time (e.g., in CG resource 1), e.g., due to a collision with a higher priority TB or a failed UL LBT. A priority index of a TB may be decremented, for example, if a (re)transmission is successful. A WTRU may decrement an initial priority index x to x-1 (e.g., if a retransmission is required), for example, if the WTRU successfully transmits the TB. In examples, the reverse may be used (e.g., priority index decrements when a transmission fails and increments when the transmission succeeds). The WTRU may maintain the priority index per grant (e.g., or configured grant) and/or use the priority index, for example, if selecting a grant (e.g., among a plurality of grants during intra-WTRU prioritization).

One or more TB prioritization rules may depend on, for example, a DCI indicated priority. A WTRU may select a TB to transmit, for example, based on the highest or lowest DCI indicated priority.

One or more TB prioritization rules may depend on, for example, an LCH priority. A WTRU may select a TB to transmit, for example, based on the priority of at least one LCH multiplexed into the TB (e.g. the highest priority LCH). A WTRU may prioritize pending TBs/transmissions and rank them by order of their highest priority LCH that is multiplexed (e.g., or may be multiplexed).

One or more TB prioritization rules may depend on, for example, whether a transmission is a first transmission or a retransmission. A WTRU may prioritize a TB based on, for example, if a previous transmission has occurred for the TB, if previous transmissions have not occurred for the TB (e.g., due to dropping or UL LBT failure), or if a transmission is or is to be the first attempt to transmit the TB.

One or more TB prioritization rules may depend on, for example, an RV of a transmission.

One or more TB prioritization rules may depend on, for example, a reason for a transmission. A prioritization may depend on whether a transmission is or is to be a first attempt at a transmission, a retransmission due to a NACK (e.g., a re-transmission of information in a TB with a NACK received on DFI may have a higher priority than a re-transmission of information in a TB with no DFI), a retransmission due to dropping (e.g., due to an intra-WTRU collision), a retransmission due to dropping (e.g. due to an inter-WTRU collision), a retransmission due to an expired CGRT, or a retransmission due to a UL LBT failure. In an example, a TB that has not been transmitted (e.g., has never been transmitted due to a failed UL LBT) may have a higher priority than a new TB (e.g., given that the never-transmitted TB has been in the buffer longer). The TB that has not been transmitted may have a higher priority than a TB that has been previously transmitted for which a retransmission is expected due to a NACK (e.g., given that a HARQ process for which the TB was NACK-ed is at least known to the gNB).

One or more TB prioritization rules may depend on, for example, the number of times a TB has not been transmitted. A WTRU may maintain a counter of the number of times a TB has been dropped (e.g., due to a collision with a higher priority TB transmission) and/or the number of times the TB is not transmitted (e.g., due to a UL LBT failure). A WTRU may use one or more counters to determine the priority associated with a TB. A counter may be reset, for example, if a TB is (re)transmitted at least once. A counter may be reset, for example, if a HARQ process is flushed. A WTRU may maintain multiple counters (e.g., two counters), for example, a first counter for dropping due to collisions with higher priority TBs and a second counter for UL LBT failures for the TB.

One or more TB prioritization rules may depend on, for example, a CAPC to be used for an LBT process to acquire a channel for a transmission.

One or more TB prioritization rules may depend on, for example, a CGT value. A priority of a TB may be determined, for example, based on the remaining time left in a CG timer associated with the TB, which may support (re)transmission of a TB before expiration of the CG timer.

One or more TB prioritization rules may depend on, for example, the content of a TB. Prioritization may depend on, for example, whether a TB includes a MAC CE and/or the type of MAC CE the TB includes (e.g., a CG confirmation MAC CE, a beam failure recovery (BFR) MAC CE, a UL LBT failure MAC CE, a cell RNTI (C-RNTI) MAC CE, and/or a buffer status report (BSR) MAC CE). A WTRU may be configured with a priority per MAC CE (e.g., or per subset of MAC CE) which the WTRU may use to compare and/or prioritize overlapping transmissions.

One or more TB prioritization rules may depend on, for example, whether a TB is part of a repetition bundle. A priority may be determined, for example, based on whether a TB is part of a repetition bundle, the number of repetitions in the bundle, and/or the number of repetitions successfully transmitted or unsuccessfully transmitted in the repetition bundle.

A WTRU may use a combination of factors (e.g., as described herein) to determine the prioritization of multiple TBs and/or to determine what TBs to transmit and/or drop. A combination may weigh different factors (e.g., by applying different weights to different factors). The weighing of factors may be configurable and/or may be determined, for example, as a function of the CG resource and/or of the timing of the transmission. One or more prioritization factors (e.g., as described herein) may not be (e.g., never be) over-ridden by one or more other factors. For example, a WTRU may maintain a priority index that may increment or decrement, e.g., based on whether a TB was previously transmitted. A priority index value of a first TB may be moot, for example, if a second TB with a specific LCH and/or MAC CE is to be (e.g., needs to be) transmitted. A second TB may have higher priority than a first TB, for example, regardless of the value of the priority index of the first TB.

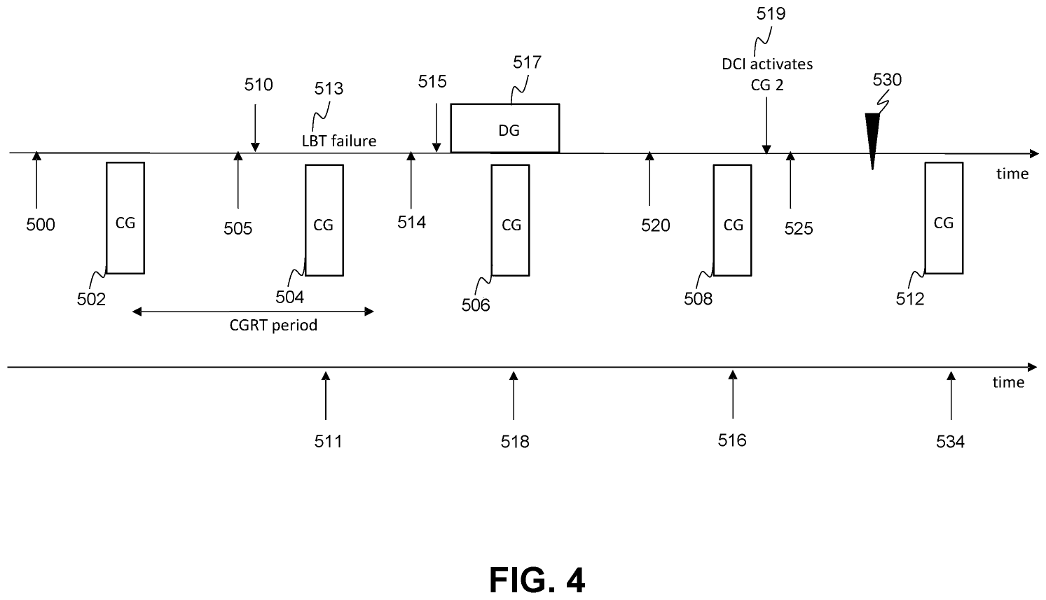

FIG. 4 illustrates an example of prioritization used to determine which information of multiple TBs to transmit, for example, on a resource associated with an occasion of a CG. The prioritization may include an intra-WTRU prioritization between retransmissions and/or initial transmissions (e.g., new transmissions). As shown at 500, a first TB (e.g., TB1) may be built, for example, as described with respect to FIGS. 2 and 3. One or more PDUs may be built to transmit first information in the first TB at 500. The first TB may be associated with a first HARQ PID (e.g., HARQ PID 1).

The WTRU may transmit first information in the first TB on a resource associated with an occasion of a CG, for example, using the one or more PDUs built at 500. As shown in FIG. 4, the WTRU may transmit the first information of the first TB on resource(s) of occasion 502 of CG1.

At 505, a second TB (e.g., TB 2) may be built for a second HARQ PID (e.g., HARQ PID 2), for example, as described with respect to FIGS. 2 and 3. One or more PDUs may be built to transmit second information of the second TB at 505. The second TB may be associated with a second HARQ PID (e.g., HARQ PID 2).

The first information of the first TB may not be received. For example, the WTRU may be in a poor coverage (e.g., limited coverage). The first information of the first TB may not be received due to the poor coverage. The WTRU may receive a feedback of the transmission of the first information. As shown in FIG. 4, at 510, the WTRU may determine NACK for HARQ PID 1. The WTRU may receive DFI (e.g., the DFI HARQ feedback (FB)) at 510. The DFI HARQ FB may indicate NACK for HARQ PID 1. As shown in FIG. 4, a CGRT may be started. For example, the CGRT may be started if the transmission of the first information of the first TB has stopped. The WTRU may determine NACK for the transmission of the first information on the resource(s) of occasion 502 of CG1 based on expiry of the CGRT. The WTRU may determine to attempt to retransmit the first information of the first TB.

The WTRU may attempt to transmit the second information of the second TB, for example, on resource(s) of occasion 504 of CG1. The attempt may not be successful. As shown in FIG. 4, the WTRU may perform LBT, and LBT failure 513 may occur.

As shown in FIG. 4, at 511, the first TB and second TB may be pending. The first information may be in a buffer of the WTRU. The second information may be in the buffer of the WTRU.

At 514, the WTRU may determine which information (e.g., the first information of the first TB, or the second information of the second TB) to transmit, for example, on resource(s) of a next occasion of CG1. The next occasion of CG1 may be occasion 506 of CG1. The determination of which information to transmit may be based on DFI reception. As shown in FIG. 4, the WTRU may determine that the first information of the first TB, for example, instead of the second information of the second TB, is to be transmitted on resource(s) of occasion 506 of CG1. The determination that the first information of the first TB is to be transmitted may be based on a DFI reception at 510 and/or no DFI is received associated with the second information of the second TB. The WTRU may not receive DFI associated with the second information of the second TB, for example, due to an LBT failure associated with the attempt to transmit the second information. In some examples, the WTRU may not receive DFI for the second information of the second TB due to a busy channel or a channel congestion (e.g., the network fails to access DFI channel even though the network receives the second information). The determination to transmit the first information of the first TB on the resource(s) of occasion 506 of CG1 may be overridden by a reception of DG or other conditions.

At 515, a DCI may be received. The DCI may indicate (e.g., schedule) a DG 517. The DG may schedule a transmission on a third HARQ PID (e.g., HARQ PID 3). The transmission may include third information of a third TB (e.g., TB3). The third information of the third TB may be transmitted on the resource(s) of occasion 506 of CG1. The first TB may be deprioritized. The determination at 514 that the first information of the first TB is to be transmitted on the resource(s) of occasion 506 of CG1 may be overridden, for example, based on an intra-WTRU prioritization. The intra-WTRU prioritization may include that the priority of DG is greater than the priority of CG. As shown in FIG. 4, at 518, the third information of the third TB may be transmitted. The first TB and second TB may be pending at 518.

At 520, the WTRU may determine which information (e.g., the first information of the first TB, or the second information of the second TB) to transmit, for example, on a resource of a next occasion of CG1. The next occasion of CG1 may include occasion 508 of CG1. The determination of which information to transmit may be based on a reason why the first information of the first TB has not been transmitted in a previous occasion (e.g., occasion 506) and/or a reason why the second information of the second TB has not been transmitted in a previous occasion (e.g., occasion 504). The first information of the first TB has not been transmitted on the resource(s) of occasion 506 of CG1 due to deprioritization. The second information of the second TB has not been transmitted on the resource(s) of occasion 504 of CG1 due to an LBT failure. The WTRU may prioritize a TB that was deprioritized, for example, due to inter-WTRU or intra-WTRU prioritization, over a TB associated with an LBT failure. The WTRU may determine that the first information of the first TB, for example, instead of the second information of the second TB, is to be transmitted on the resource(s) of occasion 508 of CG1. The first information of the first TB may be transmitted on the resource(s) of occasion 508 of CG1. At 516, the second TB and/or other TBs may be pending.

In some examples, an LBT failure may occur when the WTRU attempts to transmit the first information of the first TB on the resource(s) of occasion 508 of CG1. If an LBT failure occurs when the WTRU attempts to transmit the first information of the first TB on the resource(s) of occasion 508 of CG1, at 516, the first TB and the second TB may be pending. Other TBs may be pending at 516 due to an LBT failure. For example, a fourth TB (e.g., TB4) may be pending at 516. The fourth TB may be pending if the WTRU has built the fourth TB for HARQ PID 4. Fourth information of the fourth TB may include CG confirmation MAC CE, for example, if a DCI that activates a second CG (e.g., CG2) has been received. Occasion 508 may be of CG2, for example, if the DCI that activates CG2 has been received.

In FIG. 4, at 519, the WTRU may receive a DCI that activates the second CG. At 525, the WTRU may determine which information (e.g., the fourth information of the fourth TB, or the second information of the second TB) to transmit, for example, on resource(s) of a next occasion. The next occasion may include occasion 512. Occasion 512 may be of CG2. The determination of which information to transmit may be based a nature of a content of the second TB and/or a nature of content of the fourth TB. The WTRU may determine that the fourth information of the fourth TB, for example, instead of the second information of the second TB, is to be transmitted on occasion 512. The fourth TB may include high priority MAC CE. The determination that the fourth information of the fourth TB is to be transmitted may be based on the high priority MAC CE (e.g., a CG confirmation MAC CE) of the fourth TB and/or one or more of other conditions. For example, the other condition may be that the fourth information of the fourth TB has not been transmitted. The other condition may be that the second information of the second TB includes data (e.g., data only). The other condition may be that the second information of the second TB has been attempted to be transmitted, for example, on the resource(s) of occasion 504 of CG1. The other condition may be that the second information of the second TB has been transmitted using a previous occasion. At 534, the fourth information of the fourth TB may be transmitted, and the second TB may be pending.

In some examples, URLLC data may arrive at a buffer associated with the WTRU at 525. Some or all of the first TB, the second TB, the fourth TB, or the URLLC data may be pending at 530 if an LBT failure occurs when the WTRU attempts to transmit the first information of the first TB on the resource(s) of occasion 508 of CG1. At 530, the WTRU may determine which information, for example, the first information of the first TB, the second information of the second TB, the fourth information of the fourth TB, or the URLLC data, to be transmitted on the resource(s) of occasion 512.

A WTRU may be configured (e.g., per LCH), for example, with a flag indicating that an initial transmission of buffered data on an LCH may be prioritized (e.g., should be prioritized) over pending retransmissions.

A WTRU may prioritize between (re)transmissions, for example, based on the highest priority data and/or LCH present (e.g., or that may be transmitted) on a transmission (e.g., each transmission). Priority may be determined, for example, based on an L1 priority index and/or from L2 (e.g., based on LCH priority). A prioritization decision may operate, for example, between an initial transmission and a retransmission or between different retransmissions.

A WTRU may determine the priority of a grant (e.g., among multiple overlapping grants available for transmission) based on the channel conditions, for example, if LCH based prioritization is configured. In an example, the WTRU may determine whether a grant falls within an ongoing COT, for example, based on the start and end time of the grant. The WTRU may select a grant (e.g., among multiple overlapping grants) that is within the same COT or within a shared COT to transmit a pending TB (e.g., even if the grant overlaps with another grant that may have been deemed as higher priority per legacy intra-WTRU prioritization/selection rules, for example, if data associated with a higher priority LCH may be multiplexed on another overlapping grant that is outside the COT). In examples, the WTRU may make the decision of a grant selection, for example, based on the probability of LBT success(es) or failure(s) associated with a grant (e.g., each grant) and/or may assign a grant priority according to the probability of LBT success(es). For example, the WTRU may prioritize a grant based on the number of LBT successes (e.g., or the number of LBT failures) associated with the grant, for example, over a configured and/or predetermined observation period. The WTRU may select a grant (e.g., the grant associated with the least amount of LBT failures) from a set of overlapping grants.

A WTRU may apply the LCP restrictions applied for an initial transmission, for example, if selecting a resource for retransmission based on one or more of the following: if the retransmission is WTRU autonomous, if a CGRT is configured, or if the TB was initially transmitted on a CG/HARQ process for which a CGRT is configured. For example, the WTRU may have selected CG1 to transmit TB1 (e.g., if TB1 has data from LCH1 multiplexed which in turn has a configured LCP mapping restriction to only CG1). If autonomously retransmitting TB1, the WTRU may select CG1, for example, even if other CGs may be available (e.g., either before or during the next CG occasion associated with CG1). From a set of overlapping grants, the WTRU may exclude grants that do not meet the LCP restriction of the retransmitted TB (e.g., if selecting a grant per intra-WTRU prioritization rules). The WTRU may relax one or more LCP restrictions, for example, if the grant is within the same ongoing COT or a shared COT (e.g., if data may be multiplexed on the grant). For example, the WTRU may select a grant and/or build a TB (e.g., even if it does not meet LCP restrictions), for example, if the grant may go unused and/or the grant is within the same ongoing COT or a shared COT.

UL timing and/or latency may be maintained. A WTRU may compensate for and/or adjust a reference time delivered by a gNB. Compensation may be applied, for example, as a permanent offset and/or adjustment to a reference time. A WTRU may apply an offset to a one or more transmissions (e.g., a subset of transmissions), for example, including one or more of the following: one or more signals (e.g., all UL signaling), monitoring for DL signaling, a traffic type (e.g., URLLC-type traffic), grant type (e.g., Type-1 or Type-2 CG), transmissions for initial access (e.g., monitoring for synchronization signal block (SSB), system information block (SIB) messages, and/or transmission or reception of random access channel (RACH) messages), data (e.g., of a certain priority level and/or LCH), transmissions (e.g., with a specific or range of sub-carrier spacing(s)), a one-shot offset (e.g., for the next packet and/or transmission to be received on the DL or transmitted on the UL), and/or the like.

A WTRU capability to modify a received reference time may be based on (e.g., may rely upon) one or more WTRU capabilities. For example, a WTRU may have positioning capabilities and/or a reference clock or clock drift that meets a criterion of accuracy. In examples, an ability of a WTRU to apply a WTRU-autonomous compensation offset may be a WTRU capability, for example, which may be enabled or disabled by a network (e.g., via RRC signaling and/or a MAC CE).

Reference timing compensation may be applied, for example, based on a detection and/or a trigger. A WTRU may compensate for and/or adjust a reference time delivered by a gNB in a dynamic manner (e.g., based on or in reaction to one or more events). A WTRU may trigger a compensation action to adjust reference timing to align with a serving gNB, for example, based on one or more of the following: RSRP/RSRQ variation. reception of a transmission that is not time-aligned with a WTRU reference time. a propagation delay, arrival of data on a specific LCH and/or priority level, arrival of a specific traffic type and/or service, and/or the like.

A WTRU may trigger a compensation action to adjust reference timing to align with a serving gNB, for example, based on an RSRP/RSRQ variation. A WTRU may bigger a compensation action to adjust reference timing to align with a serving gNB, for example, based on (e.g., upon detecting) RSRP/RSRQ resources having fallen below a threshold value, risen above a threshold value, or are within one or more ranges of RSRP/RSRQ values. RSRP/RSRQ values may be associated with, for example, an estimate of distance from a serving gNB. RSRP/RSRQ values may be configured by a serving gNB, for example, via RRC signaling. RSRP/RSRQ values may be configured independently (e.g., for UL timing and/or latency) or may refer to values configured for other purposes (e.g., for measurement relaxation and/or selection of 2-step over 4-step RACH).

A WTRU may trigger a compensation action to adjust reference timing to align with a serving gNB, for example, based on reception of a transmission that is not time-aligned with a WTRU reference time. A WTRU may receive a DL transmission (e.g., an RS, PDCCH, DL data, or DL signaling from a serving gNB that the WTRU may expect at a predetermined time and/or frequency resource). A WTRU may adjust reference timing proportional to an offset, for example, based on detecting that a DL transmission arrived at a time not in synchronization with anticipated reference timing.

A WTRU may trigger a compensation action to adjust reference timing to align with a serving gNB, for example, based on a propagation delay. A WTRU may trigger a compensation action to adjust reference timing to align with a serving gNB, for example, based on a calculation of a propagation delay from the WTRU to a gNB, detecting that a propagation delay value has fallen below a threshold value, risen above a threshold value, or is within one or more ranges of propagation delay values. Propagation delay values may be configured by the network e.g., via RRC signaling. A propagation delay may be estimated by a WTRU, for example, via knowledge of WTRU and/or gNB location (e.g., via global positioning system (GPS) and/or global navigation satellite system (GNSS) techniques), or via network positioning techniques.

A WTRU may trigger a compensation action to adjust reference timing to align with a serving gNB, for example, based on arrival of data on a specific (e.g., configured, indicated, and/or selected) LCH and/or priority level.

A WTRU may trigger a compensation action to adjust reference timing to align with a serving gNB, for example, based on arrival of specific (e.g., configured, indicated, and/or selected) traffic type and/or service.

A WTRU may update (e.g., periodically update) a reference time. The periodicity of reference timing updates may be based on a timer. The applicability of the timer and timer value(s) may be configured by a network, e.g., via RRC signaling. An update to reference timing may be triggered (e.g., by a WTRU), for example, upon timer expiry. A WTRU may reset a timer, for example, based on reception of one or more of the following: a timing advance MAC CE, an absolute timing advance MAC CE, a timing advance included in Msg3 or MsgB, a WTRU-based modification of reference timing (e.g., based on a propagation delay estimation and/or compensation), and/or the like.

The periodicity of updating reference timing may be based on a counter. A counter may be based on, for example, a number of frames, slots, and/or symbols, for example, which may be configured by a network. A WTRU may trigger an action related to updating reference timing, for example, based on reaching a predetermined number of resources. A WTRU may reset a counter, for example, based on reception of one or more of the following: a timing advance MAC CE, an absolute timing advance MAC CE, a timing advance included in Msg3 or MsgB, WTRU-based modification of reference timing (e.g., based on propagation delay estimation and/or compensation), and/or the like.

A periodicity of updating reference timing may be dependent on WTRU and/or data characteristics, for example, which may be configured (e.g., explicitly or implicitly configured). A periodicity of a WTRU updating reference timing may be based on (e.g., associated with), for example, one or more of the following: a service type, WTRU speed, a grant type, a priority of data and/or an LCH, and/or the like.

A periodicity of a WTRU updating reference timing may be based on, for example, a service type. A WTRU may have different timing expectations (e.g., timing requirements) associated with different data types. For example, a WTRU with URLLC or time-sensitive communications (TSC) traffic may perform reference timing updates with a greater periodicity than for eMBB data.

A periodicity of a WTRU updating reference timing may be based on, for example, a WTRU speed. A WTRU may use a higher frequency of reference timing updates, for example, if the WTRU is in a high-mobility state. A WTRU may be determined to be in a high-mobility state, for example, based on one or more of the following: a mobility state estimation flag, internal sensors (e.g., accelerometers), the number of handovers performed in a given time, detection of large variations in one or more consecutive propagation delays, positioning, RSRP/RSRQ measurements, the type of gNB the WTRU is connected to (e.g., an NTN satellite), and/or the like.

A periodicity of a WTRU updating reference timing may be based on, for example, a grant type. For example, a WTRU with a semi-persistent and/or configured grant resource (e.g., Type 1 or Type 2 grant resource) may perform reference timing updates more frequently than a WTRU transmitting data via a dynamic grant.

A periodicity of a WTRU updating reference timing may be based on, for example, a priority of data and/or an LCH.

A WTRU may acquire a compensation value to apply to an initial reference time. A WTRU may detect that reference timing provided by a gNB expects (e.g., needs) an offset, for example, based on one or more of the following: WTRU estimation of propagation delay, in reaction to an offset transmission, a measurement, based on expiry of a timer or based on reaching a counter value, and/or the like. A WTRU may perform one or more actions to a reference time and/or to one or more transmissions (e.g., a subset of transmissions), for example, based on a detection that reference timing provided by a gNB expects (e.g., needs) an offset (e.g., and based on/subject to WTRU capability and/or if WTRU compensation is enabled by the network). The one or more actions a WTRU may perform to a reference time and/or to one or more transmissions may include, for example, one or more of the following: apply an estimated timing correction, notify a gNB of possible timing drift, transmit a RACH message to receive a timing advance to align with the clock, and/or the like.

A WTRU may apply an estimated timing correction. A timing correction may be based on a (calculation (e.g., an explicit calculation such as a propagation delay to a network node and/or an offset observed between an expected time and actual reception time of a transmission). A WTRU may choose from a subset of pre-configured values, for example, which may be linked to a specific measurement. For example, the WTRU may have an association of timing value to apply with an RSRP/RSRQ value or range of values.

A WTRU may notify a gNB of a possible timing drift. A WTRU may notify a gNB (e.g., through explicit signaling), for example, based on detecting that a received reference time from a gNB may need an offset (e.g., an additional offset). Signaling may be, for example, a flag in UCI or via HARQ feedback to, for example, a timing advance command MAC CE. A WTRU may notify (e.g., notify implicitly) a gNB, for example, by applying a timing offset to future UL transmissions. A WTRU may provide a gNB an estimate of a needed and/or requested timing offset. A WTRU may perform (e.g., be configured to perform) one or more of the following actions: receive and apply a MAC CE (e.g., an absolute timing advance MAC CE or a timing advance MAC CE) and/or monitor for timing advance in Msg2/MsgB.

A WTRU may transmit a RACH message to receive a timing advance to align with the clock. A WTRU may perform RACH to receive a timing advance (TA) command in Msg2 or Msg4, for example, based on detecting an offset in reference time (e.g., to synchronize timing).

UL timing, latency, and/or mobility may be maintained. A WTRU may (e.g., based on mobility) adjust a reference time provided by a source cell to meet synchronization at the target cell. A WTRU may use a TA command provided by a target cell to adjust a reference time and/or to apply propagation delay compensation. A WTRU may apply a timing offset, for example, based on handover to a cell (e.g., a cell neighboring the cell from which the reference time was provided). A timing offset may be provided, for example, by a former serving gNB. A timing offset may be calculated (e.g., calculated explicitly) by the WTRU, for example, based on information provided by a network (e.g., geographic location of the target cell).

In examples, there may be a master clock provided by a network, another WTRU, or via an external source, such as a dedicated function, that may account for various propagation delays. For example, a WTRU may receive master clock information using GPS and/or GNSS information. A WTRU may determine that a reference time is shared by multiple WTRUs and/or gNBs (e.g., all WTRUs and/or gNBs) within an area, such as a RAN notification area (RNA) or a tracking area, or within gNBs belonging to a TSN network. A WTRU may (e.g., prior to mobility and/or initial access) synchronize the WTRU's grand master clock, for example, to support proper timing prior to cell access.

A WTRU may be configured with a validity timer (e.g., throughout which the pre-compensation or timing value applied is determined to be correct). In examples, the WTRU may obtain (e.g., calculate) and/or apply an additional timing correction, for example, based on expiry of a timer (e.g., the validity timer). The WTRU may report to the network that the WTRU has updated the timing value, for example, including the calculated timing value.

In examples, validity timer expiry may trigger the WTRU to transmit a notification and/or a request to the network for verification that the time correction is valid. The WTRU may include one or more of, for example, the current timing compensation applied, when the timing compensation was applied, and/or whether it was a network-calculated compensation value or WTRU-calculated compensation value.

Timing compensation (e.g., WTRU-based timing compensation) may be activated and/or controlled.

A WTRU may (e.g., may be required to) activate or deactivate timing pro-compensation. A WTRU may, for example, based on reception and/or detection of an activation indication/command, obtain (e.g., calculate) a timing compensation value and may apply (e.g., immediately apply) the compensated and/or corrected value. In examples, a WTRU may be provided (e.g., additionally provided) and/or pre-configured with a threshold, for example, where if the timing correction is below a threshold, the WTRU may ignore the timing compensation indication. In examples herein, timing correction and timing compensation may be used interchangeably.

If the WTRU receives a de-activation command and/or indication, the WTRU may, for example, refrain from calculating a timing compensation value and/or may rely on a network correction or maintain calculating WTRU-based timing compensation value(s) and refrain from applying the value(s), for example, unless indicated by the network (e.g., a one-shot command or re-activation of WTRU-based compensation).

Activation or deactivation of WTRU-based timing compensation may be semi-statically configured. A WTRU may activate (e.g., or deactivate WTRU-based timing compensation), for example, for a period or until reception of an indication to deactivate (e.g., or activate) the compensation. In examples, the WTRU may be dynamically indicated (e.g., via an indication to deactivate or activate the compensation), for example, via a MAC CE or DCI.

Activation or deactivation of timing compensation may be indicated (e.g., indicated explicitly) to a WTRU, for example, via one or more of the following: system information or SIB(s) (e.g., the WTRU may detect in SIB(s) whether the WTRU is configured and/or expected to apply WTRU-based compensation in the cell), RRC signaling, DCI, and/or MAC CE. The WTRU may be provided with, for example, a timing advance MAC CE that may provide a timing pre-compensation. In examples, a different MAC CE (e.g., a second and/or new MAC CE) may be received with a finer granularity of timing advance (e.g., specifically for TSN compensation).

In examples, a WTRU may be implicitly indicated to activate or deactivate WTRU-based timing compensation using one or more of the following techniques: if timing advance is provided by gNB (e.g., if the WTRU receives timing compensation (e.g., a MAC CE or TA command in Msg3), the WTRU may determine that timing compensation is under network control and/or deactivate WTRU-based timing compensation), if a TA command is not received in Msg3 (e.g., if no TA command is received, the WTRU may activate WTRU-based timing compensation), if RSRP is above (e.g., or below) a threshold (for example, the WTRU may activate WTRU-based timing compensation if the RSRP is below a pre-configured threshold; in some example, if the WTRU detects that RSRP is above a threshold, it may deactivate WTRU-based pre-compensation), 2-step RACH (e.g., if the WTRU uses 2-step RACH, the WTRU may deactivate or not apply WTRU-based timing compensation), based on deployment scenario, based on a WTRU location and/or a distance to a cell center (e.g., if the WTRU detects that it is near a cell center, the WTRU may deactivate WTRU-based timing compensation. In some examples, if the WTRU detects that it is a pre-configured distance away from the cell center or a TRP, the WTRU may activate WTRU-based timing compensation techniques) and/or the like.

A WTRU, for example, based on a reception of an implicit indication to activate/deactivate WTRU timing compensation, may satisfy (e.g., be required to satisfy) one or more further criteria before activating/deactivating WTRU-based pre-compensation (e.g., if the RSRP is above a threshold or if a pre-determined amount of time has elapsed before the WTRU has applied a previous update).

In examples, if a WTRU detects one or more of techniques described herein to implicitly indicate an activation or deactivation of WTRU-based compensation, the WTRU may trigger a request to the network to verify that WTRU-based timing compensation has been activated or deactivated. The WTRU may indicate (e.g., additionally indicate) one or more of, for example, the implicit indication type which was detected, the current RSRP, the current timing compensation value, and/or the current timing compensation technique.

A discrepancy between WTRU and network calculated pre-compensation may be resolved.

A WTRU, for example, regardless of a TSN deployment scenario, or if pre-compensation is performed by the network, may periodically calculate a pre-compensation value (e.g., even if the WTRU does not apply the value). The WTRU may compare the calculated value to the compensation value that has been provided by the network or the current timing correction. In examples, if a value (e.g., a delta value) diverges outside of a configured threshold, the WTRU may report one or more of, for example, that a discrepancy has occurred, the WTRU calculated value, the delta value between the WTRU calculated, and/or network calculated value. A threshold may be configured by the network and/or may depend on the TSN deployment scenario and/or timing requirements.

Although features and elements described above are described in particular combinations, each feature or element may be used alone without the other features and elements of the preferred embodiments, or in various combinations with or without other features and elements.

Although the implementations described herein may consider 3GPP specific protocols, it is understood that the implementations described herein are not restricted to this scenario and may be applicable to other wireless systems. For example, although the solutions described herein consider LTE, LTE-A, New Radio (NR) or 5G specific protocols, it is understood that the solutions described herein are not restricted to this scenario and are applicable to other wireless systems as well.

The processes described above may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as compact disc (CD)-ROM disks, and/or digital versatile disks (DVDs). A processor in association with software may be used to implement a radio frequency transceiver for use in a WTRU, terminal, base station, RNC, and/or any host computer.

1-18. (canceled)

19. A device comprising:
a processor configured to:
receive configuration information that indicates a plurality of resources associated with a configured grant (CG);
determine a first transport block (TB) and a second TB, wherein the first TB is associated with first information and the second TB is associated with second information; and
send a transmission using a first resource of the plurality of resources associated with the CG, wherein:
the transmission comprises the first information based on a fulfillment of a first plurality of conditions, wherein the first plurality of conditions comprises a condition that first feedback for a first prior transmission comprising the first information has been received by the device and indicates that the first information has not been received, and a condition that second feedback for a second prior transmission comprising the second information has not been received by the device, and
the transmission comprises the second information based on a fulfillment of a second plurality of conditions, wherein the second plurality of conditions comprises a condition that the second TB has been de-prioritized for a second resource prior to the first resource and the second information has not been transmitted, and a condition that a listen before talk (LBT) failure associated with the first TB has occurred on a third resource prior to the first resource and the first information has not been transmitted.

20. The device of claim 19, wherein the processor is further configured to determine whether to send the first information or the second information in the transmission, and wherein the first information is determined to be sent in the transmission based on a fulfillment of a third plurality of conditions, wherein the third plurality of conditions comprises a condition that the first information comprises control information and has not been transmitted and a condition that the second information does not comprise the control information and has been transmitted.

21. The device of claim 19, wherein the processor is further configured to determine whether to send the first information or the second information in the transmission, and wherein the first information is determined to be sent in the transmission based on a fulfillment of a fourth plurality of conditions, wherein the fourth plurality of conditions comprises a condition that the first information comprises medium access control (MAC)-control element (CE) and has not been transmitted and a condition that the second information does not comprise control information and has been transmitted.

22. The device of claim 19, wherein the configuration information indicates a physical uplink control channel (PUCCH) transmission occasion associated with the CG, and the first resource is associated with the PUCCH transmission occasion.

23. The device of claim 19, wherein the first feedback comprises downlink feedback information (DFI) on the first prior transmission.

24. The device of claim 19, wherein the first prior transmission is a most recent transmission of the first information, and the second prior transmission is a most recent transmission of the second information.

25. The device of claim 19, wherein the first prior transmission comprises a physical uplink channel (PUCCH) transmission occasion associated with the CG or a PUCCH transmission associated with an uplink grant.

26. The device of claim 19, wherein the processor is further configured to determine whether to send the first information or the second information in the transmission, and the transmission is sent based on the determination of whether to send the first information or the second information in the transmission.

27. The device of claim 19, wherein the device comprises a wireless transmit/receive unit (WTRU).

28. A method performed by a device, comprising:
receiving configuration information that indicates a plurality of resources associated with a configured grant (CG);
determining a first transport block (TB) and a second TB, wherein the first TB is associated with first information and the second TB is associated with second information; and
sending a transmission using a first resource of the plurality of resources associated with the CG, wherein:
the transmission comprises the first information based on a fulfillment of a first plurality of conditions, wherein the first plurality of conditions comprises a condition that first feedback for a first prior transmission comprising the first information has been received by the device and indicates that the first information has not been received, and a condition that second feedback for a second prior transmission comprising the second information has not been received by the device, and
the transmission comprises the second information based on a fulfillment of a second plurality of conditions, wherein the second plurality of conditions comprises a condition that the second TB has been de-prioritized for a second resource prior to the first resource and the second information has not been transmitted, and a condition that a listen before talk (LBT) failure associated with the first TB has occurred on a third resource prior to the first resource and the first information has not been transmitted.

29. The method of claim 28, further comprising determining whether to send the first information or the second information in the transmission, and wherein the first information is determined to be sent in the transmission based on a fulfillment of a third plurality of conditions, wherein the third plurality of conditions comprises a condition that the first information comprises control information and has not been transmitted and a condition that the second information does not comprise the control information and has been transmitted.

30. The method of claim 28, further comprising determining whether to send the first information or the second information in the transmission, and wherein the first information is determined to be sent in the transmission based on a fulfillment of a fourth plurality of conditions, wherein the fourth plurality of conditions comprises a condition that the first information comprises medium access control (MAC)-control element (CE) and has not been transmitted and a condition that the second information does not comprise control information and has been transmitted.

31. The method of claim 28, wherein the configuration information indicates a physical uplink control channel (PUCCH) transmission occasion associated with the CG, and the first resource is associated with the PUCCH transmission occasion.

32. The method of claim 28, wherein the first prior transmission is a most recent transmission of the first information, and the second prior transmission is a most recent transmission of the second information.

33. The method of claim 28, wherein the first prior transmission comprises a physical uplink channel (PUCCH) transmission occasion associated with the CG or a PUCCH transmission associated with an uplink grant.

34. The method of claim 28, wherein the first feedback comprises downlink feedback information (DFI) on the first prior transmission.

35. The method of claim 28, further comprising determining whether to send the first information or the second information in the transmission, and the transmission is sent based on the determination of whether to send the first information or the second information in the transmission.
